(19) United States
(12) Patent Application Publication
(10) Pub. No.: US 2014/0118260 A1
(43) Pub. Date: May 1, 2014

(54) MOBILE TERMINAL AND METHOD FOR MOVING CURSOR THEREOF

(71) Applicants: Yilin Chen, Shenzhen (CN); Yiting Zeng, Shenzhen (CN); Junxuan Lin, Shenzhen (CN); Haowen Wang, Shenzhen (CN); Zhiping Zhang, Shenzhen (CN); Qiuyu Lv, Shenzhen (CN)

(72) Inventors: Yilin Chen, Shenzhen (CN); Yiting Zeng, Shenzhen (CN); Junxuan Lin, Shenzhen (CN); Haowen Wang, Shenzhen (CN); Zhiping Zhang, Shenzhen (CN); Qiuyu Lv, Shenzhen (CN)

(73) Assignee: ZTE CORPORATION, Shenzhen (CN)

(21) Appl. No.: 14/126,027

(22) PCT Filed: Aug. 15, 2011
(86) PCT No.: PCT/CN2011/078432

§ 371 Date: Dec. 13, 2013

(30) Foreign Application Priority Data
Jun. 20, 2011 (CN) 201110165570.2

(51) Int. Cl. G06F 3/0346

(52) U.S. Cl. CPC G06F 3/0346
USPC 345/158

(57) ABSTRACT

The disclosure discloses a mobile terminal and method for implementing movement of a cursor thereof. The method includes: acquiring accelerated velocities aₓ, a_{y}, and a_{z} of a mobile terminal in a set three-dimensional coordinate system; calculating a current left/right tilt rate K1 and a current forward/backward tilt rate K2 of the mobile terminal; and moving a cursor left/right or forward/backward based on the tilt rate K1 and the tilt rate K2. The mobile terminal includes: an information acquiring unit, a tilt rate calculating unit and a cursor moving unit. With the method of the disclosure, a user needs only to tilt a mobile terminal in all directions to move a cursor at will. The severer tilt is, the faster the cursor moves. In this way, the trouble of repeated touch or key-press is reduced, high efficiency and convenience is achieved, and user experience is enhanced.

### TECHNICAL FIELD

The disclosure relates to the field of mobile communication technology, and in particular to a mobile terminal and a method for implementing movement of a cursor thereof.

### BACKGROUND

In a current consumer market for mobile terminals, functions of a mobile terminal are becoming more and more enrichment and standardization. Real enhancement of a user experience level of a mobile terminal is becoming a key to well selling of the mobile terminal. For most of existing mobile terminals, a method for moving a text cursor in the process of inputting is completed by a direction key or by touching and directly clicking. Such two methods seem intuitive whereas they have some disadvantages and limitations. Firstly, touch-screen mobile terminals are becoming more popular at present, most of which cancel hard keyboard support. Secondly, middle-end and high-end mobile terminals are increasingly using a capacitive screen. Although the capacitive screen is more sensitive, it has a great disadvantage of inaccuracy of clicking. Therefore, it is difficult to position the cursor accurately by touching. Thirdly, a full-screen handwriting input method is more and more popular, but many mobile terminals fail to switch the position of a cursor by a touch screen in the case of full screen handwriting. These disadvantages affect user experience for mobile terminals.

### SUMMARY

The disclosure provides a mobile terminal and a method for implementing movement of a cursor thereof, so as to solve the problem of inaccuracy of cursor positioning and affecting user experience in the related art.

In order to solve the aforementioned problem, the disclosure provides a method for implementing movement of a cursor by a mobile terminal, which includes:

acquiring accelerated velocities aₓ, a_{y}, and a_{z} of a mobile terminal in a set three-dimensional coordinate system;

calculating a current left/right tilt rate K1 and a current forward/backward tilt rate K2 of the mobile terminal; and

moving a cursor left/right or forward/backward based on the tilt rate K1 and the tilt rate K2.

Wherein, “/” in left/right and forward/backward refers to the meaning of the wording “or”.

In the method of the disclosure, the step of acquiring accelerated velocities aₓ, a_{y}, and a_{z} of a mobile terminal in a set three-dimensional coordinate system may include:

subscribing an acceleration induction vector GVector event, and acquiring the accelerated velocities aₓ, a_{y}, and a_{z} of the mobile terminal in set three-dimensional coordinate axes according to acquired GVector information in real time.

In the method of the disclosure, the step of calculating a current left/right tilt rate K1 and a current forward/backward tilt rate K2 of the mobile terminal may include:

according to the accelerated velocities aₓ, a_{y}, and a_{z}, obtaining the left/right tilt rate K1 using aₓ/a_{y}, and obtaining the forward/backward tilt rate K2 using a_{y}/a_{z}.

In the method of the disclosure, the step of moving a cursor left/right or forward/backward based on the tilt rate K1 and the tilt rate K2 may include:

step 41: starting a preset left/right movement timeout timer T1 and a preset forward/backward movement timeout timer T2;

step 42: when the timer T1 or the timer T2 expires, determining whether the tilt rate |K1| or the tilt rate |K2| exceeds a set threshold; and

step 43: when the tilt rate |K1| or the tilt rate |K2| exceeds the set threshold, moving the cursor one grid left/right or forward/backward, continuing to determining movement of the cursor based on the current |K1| or |K2|, and returning to the step 41.

In the method of the disclosure, timing time of the timer T1 and timing time of the timer T2 may be preset fixed values; or, timing time of the timer T1 may be T1=A1/|K1| and timing time of the timer T2 may be T2=A2/|K2|, wherein A1 and A2 may be constants; and

when T1=A1/|K1| and T2=A2/|K2|, in the step 43, before the step 41 is returned to, the timing time T1 or T2 is re-calculated based on the current |K1| or |K2|.

In the method of the disclosure, before acquiring the accelerated velocities aₓ, a_{y}, and a_{z} of the mobile terminal in the set three-dimensional coordinate system, the method may further include;

determining whether a movement function of a gravity induction cursor is enabled, and when the movement function of the gravity induction cursor is enabled, triggering an operation of acquiring the accelerated velocities aₓ, a_{y}, and a_{z} of the mobile terminal in the set three-dimensional coordinate system.

The disclosure further provides a mobile terminal, which includes:

an information acquiring unit configured to acquire accelerated velocities aₓ, a_{y}, and a_{z} of a mobile terminal in a set three-dimensional coordinate system;

a tilt rate calculating unit configured to calculate a current left/right tilt rate K1 and a current forward/backward tilt rate K2 of the mobile terminal; and

a cursor moving unit configured to move a cursor left/right or forward/backward based on the tilt rate K1 and the tilt rate K2.

Wherein, the information acquiring unit may be configured to subscribe an acceleration induction vector GVector event, and acquire the accelerated velocities aₓ, a_{y}, and a_{z} of the mobile terminal in set three-dimensional coordinate axes according to acquired GVector information in real time;

the tilt rate calculating unit may be configured to, according to the accelerated velocities aₓ, a_{y}, and a_{z}, obtain the left/right tilt rate K1 using aₓ/a_{y}, and obtain the forward/backward tilt rate K2 using a_{y}/a_{z}; and

the cursor moving unit may further include:

a timing sub-unit configured to start a preset left/right movement timeout timer T1 and a preset forward/backward movement timeout timer T2;

a determining sub-unit configured to, when the timer T1 or the timer T2 expires, determine whether the tilt rate |K1| or the tilt rate |K2| exceeds a set threshold; and a cursor moving sub-unit configured to: when the tilt rate |K1| or the tilt rate |K2| exceeds the set threshold, move the cursor one grid left/right or forward/backward, continue to determining movement of the cursor based on the current |K1| or |K2|, and trigger the timing sub-unit.

Wherein, in the timing sub-unit, timing time of the timer T1 and timing time of the timer T2 may be preset fixed values; or, timing time of the timer T1 may be T1=A1/|K1| and timing time of the timer T2 may be T2=A2/|K2|, wherein A1 and A2 may be constants;

when T1=A1/|K1| and T2=A2/|K2|, before the cursor moving sub-unit triggers the timing sub-unit, the timing time T1 or T2 is re-calculated based on the current |K1| or |K2|.

Further, the mobile terminal of the disclosure may further include:

a detecting unit configured to: determine whether a movement function of a gravity induction cursor is enabled, and trigger the information acquiring unit when the movement function of the gravity induction cursor is enabled.

Compared with the related art, the disclosure has the following beneficial effects:

with the method and the device of the disclosure, a user needs only to tilt a mobile terminal in all directions to move a cursor at will. The severer tilt is, the faster the cursor moves. In this way, the trouble of repeated touch or key-press is reduced, high efficiency and convenience is achieved, and user experience is enhanced.

### BRIEF DESCRIPTION OF THE DRAWINGS

FIG. 1 is a flowchart of a method for implementing movement of a cursor by a mobile terminal according to the disclosure;

FIG. 2 is a flowchart of a method for implementing movement of a cursor by a mobile terminal according to an embodiment of the disclosure;

FIG. 3 is a schematic diagram of a three-dimensional coordinate system of a mobile terminal defined in an embodiment of the disclosure; and

FIG. 4 is a diagram of a structure of a mobile terminal according to the disclosure.

### DETAILED DESCRIPTION

A clear and complete description will be performed on the technical solution of embodiments of the disclosure below with reference to the drawings in the embodiments of the disclosure. Obviously, the described embodiments are merely a part of embodiments of the disclosure instead of all embodiments. Based on the embodiments of the disclosure, all other embodiments obtained by those skilled in the art without paying any creative labour should fall within the scope of protection of the disclosure.

In order to solve the problem existing in the related art, the disclosure provides a mobile terminal and a method for implementing movement of a cursor thereof. The disclosure uses a gravity inductor of a mobile terminal to automatically move a cursor according to a direction and level of a tilt of the mobile terminal instead of touch or key-press, which enhances convenience greatly.

Wherein, the gravity inductor is also referred to as an acceleration inductor, which is a device of converting an acceleration signal of a medium into an electric signal. The medium produces formation under acceleration to generate a tiny voltage. By means of measuring such voltage, accelerated velocities of the medium in all directions of a three-dimensional space can be obtained, thereby obtaining a state of motion or a horizontal tilt degree of a mobile terminal.

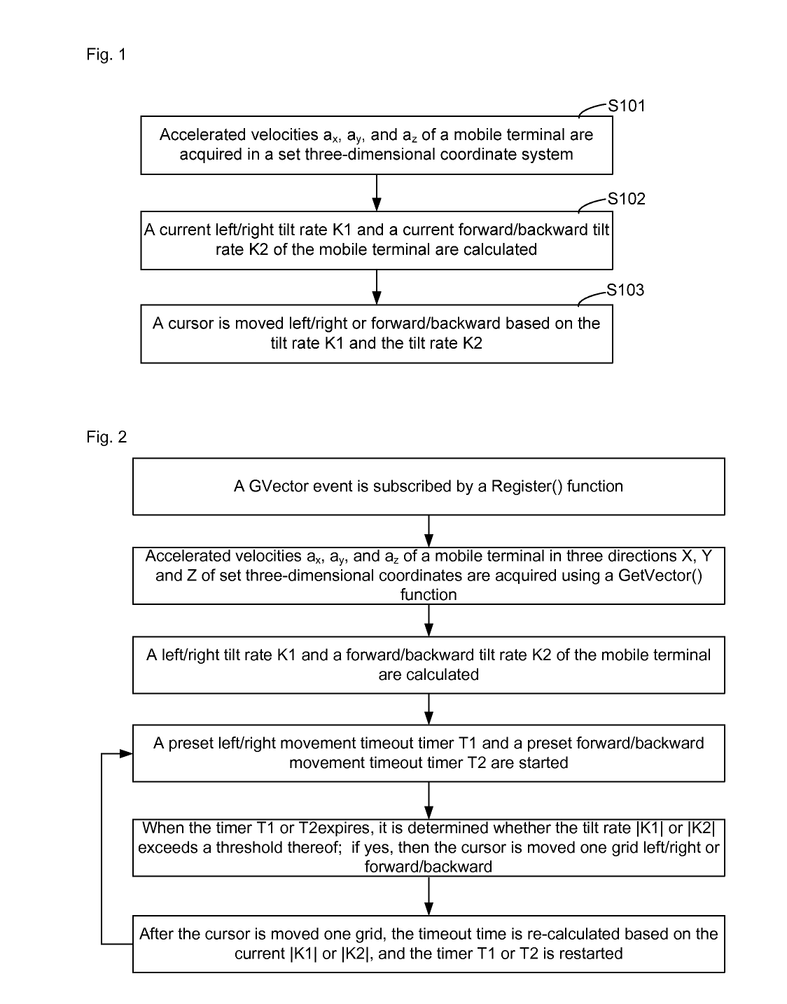

As shown in FIG. 1, a method for implementing movement of a cursor by a mobile terminal provided by the disclosure includes the following steps:

S101: Accelerated velocities aₓ, a_{y}, and a_{z} of a mobile terminal are acquired in a set three-dimensional coordinate system;

S102: A current left/right tilt rate K1 and a current forward/backward tilt rate K2 of the mobile terminal are calculated; and

S103: A cursor is moved left/right or forward/backward based on the tilt rate K1 and the tilt rate K2.

In step S103, the step of moving a cursor left/right or forward/backward based on the tilt rate K1 and the tilt rate K2 specifically includes:

(1) a preset left/right movement timeout timer T1 and a preset forward/backward movement timeout timer T2 are started;

(2) when the timer T1 or the timer T2 expires, it is determined whether the tilt rate |K1| or the tilt rate |K2| exceeds a set threshold; and

(3) when the tilt rate |K1| or the tilt rate |K2| exceeds the set threshold, the cursor is moved one grid left/right or forward/backward, it continues to determining movement of the cursor based on the current |K1| or |K2|, and the step (1) is returned to.

Wherein, timing time of the timer T1 and timing time of the timer T2 are preset fixed values; or, timing time of the timer T1 is T1=A1/|K1| and timing time of the timer T2 is T2=A2/|K2|, wherein A1 and A2 are constants; and

when T1=A1/|K1| and T2=A2/|K2|, in the step (3), before the step (1) is returned to, the timing time T1 or T2 is re-calculated based on the current |K1| or |K2|.

Preferably, before executing step S101, the method further includes:

it is determined whether a movement function of a gravity induction cursor is enabled, and when the movement function of the gravity induction cursor is enabled, an operation of acquiring the accelerated velocities aₓ, a_{y}, and a_{z} of the mobile terminal in the set three-dimensional coordinate system in step S101 is triggered.

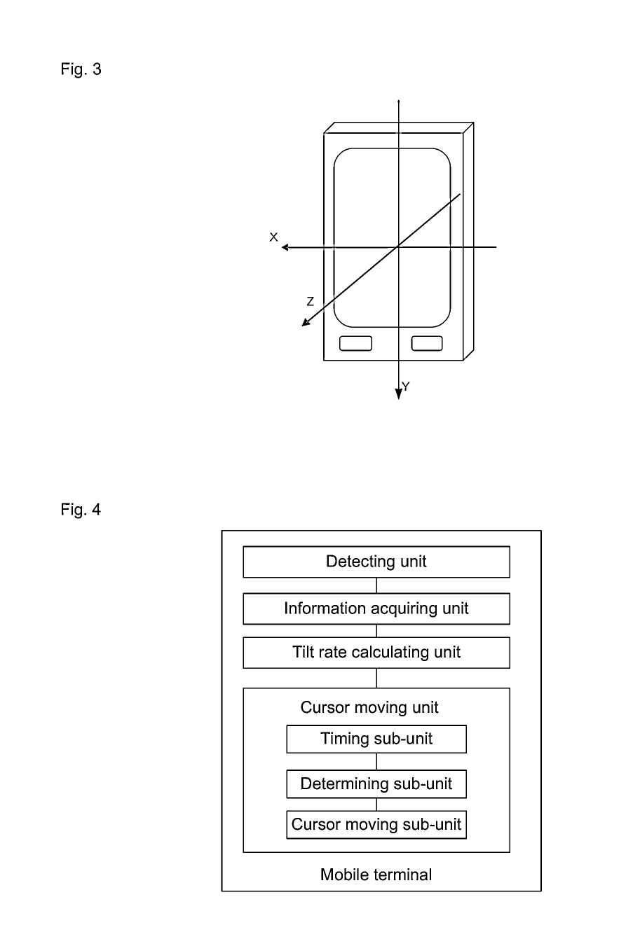

Two preferable embodiments of the disclosure are given below with reference to FIG. 2 and FIG. 3, and technical detail of the disclosure is further given in combination with description of embodiments.

### EMBODIMENT 1

As shown in FIG. 2, an embodiment of the disclosure provides a method for implementing movement of a cursor by a mobile terminal, which includes:

S201: A GVector event is subscribed by a Register( )function.

After the GVector event is subscribed, the GVector event can be received when an acceleration status is changed.

S202: Accelerated velocities aₓ, a_{y}, and a_{z} of a mobile terminal in three directions X, Y and Z of set three-dimensional coordinates are acquired using a GetVector( ) function. Wherein, the original point of the established three-dimensional coordinate system X, Y and Z is preferably a centre-of-gravity position of the mobile terminal.

In the embodiment, taking a mobile terminal in vertical screen movement as an example, and as shown in FIG. 3, a direction of a lateral edge of the mobile terminal is taken as X axis and the left direction is the positive direction, a direction of a vertical edge of the mobile terminal is taken as Y axis and the backward direction is the positive direction, and a direction perpendicular to a plane of the mobile terminal is taken as Z axis and the direction pointing to a user is the positive direction. Accelerated velocities on obtained three axes are defined as aₓ, a_{y}, and a_{z} respectively. Wherein, obtained accelerated velocities aₓ, a_{y}, and a_{z} are different according to a moving direction of the mobile terminal. Based on set positive directions of coordinate axes, the accelerated velocities aₓ, a_{y}, and a_{z} can be either positive values or negative values. A specific symbol is determined according to a tilt direction of the mobile terminal.

S203: A left/right tilt rate K1 and a forward/backward tilt rate K2 of the mobile terminal are calculated, wherein K1=aₓ/a_{y} and K2=a_{y}/a_{z}.

In the step, when K1 is 0, the mobile terminal does not tilt in an XY plane, when K1 is greater than 0, it is indicated that the mobile terminal tilts to the left, and when K1 is less than 0, it is indicated that the mobile terminal tilts to the right. The greater the absolute value of K1 is, the severer the tilt is.

In a similar way, when K2 is 0, the mobile terminal is placed horizontally, when K2 is less than 0, it is indicated that the mobile terminal tilts backward, and when K2 is greater than 0, it is indicated that the mobile terminal tilts forward. The greater the absolute value of K2 is, the severer the tilt is.

S204: A preset left/right movement timeout timer T1 and a preset forward/backward movement timeout timer T2 are started. Wherein, for the timers T1 and T2, timeout time can be defined as a fixed value, but is preferably defined as: T1=A1/|K1| and T2=A2/|K2|, wherein A1 and A2 are constants. A user can also adjust a movement speed of a cursor by setting values of A1 and A2. The timeout time T1 and T2 is inversely proportional to the absolute value of a tilt rate K. Subsequent steps of the embodiment of the disclosure are described by taking T1=A1/|K1| and T2=A2/|K2| as example.

S205: When the timer T1 expires, it is determined whether the tilt rate |K1| exceeds a set threshold L1 thereof; if yes, then the cursor is moved one grid left or right (K1 is positive or negative); and

when the timer T2 expires, it is determined whether the tilt rate |K2| exceeds a set threshold L2 thereof; if yes, then the cursor is moved one grid upward or downward (K2 is positive or negative).

S206: After the cursor is moved one grid, the timeout time is re-calculated based on the current |K1| or |K2|, the timer T1 or T2 is restarted, and step S204 is returned to.

Using the above method to proceed, the edited movement speed of the cursor will be adjusted automatically according to a |Kn| value. When |Kn| is less than the threshold thereof, the cursor is not moved, and when |Kn| is greater than the threshold thereof, the greater |Kn| is, the less timing time Tn is, and the faster the cursor moves, wherein n=1 or 2.

In an embodiment of the disclosure, a user can also adjust the movement speed of the cursor by setting A1 and A2 values, or adjust the movement speed of the cursor by setting A1 and A2 values, so as to meet different habits and requirements of users.

### EMBODIMENT 2

A method for implementing movement of a cursor by a mobile terminal in the embodiment of the disclosure is substantially the same as that in embodiment 1, and differs in that in the embodiment of the disclosure, before movement of the cursor is performed using a gravity inductor, it is determined whether a movement function of a gravity induction cursor is enabled. When the movement function of the gravity induction cursor is enabled, acceleration information of the mobile terminal is calculated according to a subscribed GVector event, thus achieving the movement of the cursor.

In the embodiment of the disclosure, in order to avoid that a cursor is moved by a user at will due to unintentional movement or rotary movement of the mobile terminal during a process of input and thus a normal use is affected, an on-off key may be arranged at a soft keyboard or an edge of the mobile terminal. When the on-off key is pressed, the movement function of the gravity induction cursor is enabled, and the cursor can be moved by gravity induction. In this way, not only convenience of an operation is ensured, but also no negative effect is caused due to random movement of the cursor.

To sum up, with the method of the disclosure, a user needs only to press a movement on-off key during the process of editing, and tilts a mobile terminal in all directions so as to move a cursor at will. The severer tilt is, and the faster the cursor moves. In this way, the trouble of repeated touch or key-press is reduced, high efficiency and convenience is achieved, and user experience is enhanced.

As shown in FIG. 4, the disclosure further provides a mobile terminal, which includes:

an information acquiring unit configured to acquire accelerated velocities aₓ, a_{y}, and a_{z} of a mobile terminal in a set three-dimensional coordinate system;

a tilt rate calculating unit configured to calculate a current left/right tilt rate K1 and a current forward/backward tilt rate K2 of the mobile terminal; and

a cursor moving unit configured to move a cursor left/right or forward/backward based on the tilt rate K1 and the tilt rate K2.

Wherein, the information acquiring unit is configured to subscribe an acceleration induction vector GVector event, and acquire the accelerated velocities aₓ, a_{y}, and a_{z} of the mobile terminal in set three-dimensional coordinate axes according to acquired GVector information in real time;

the tilt rate calculating unit is configured to, according to the accelerated velocities aₓ, a_{y}, and a_{z}, obtain the left/right tilt rate K1 using aₓ/a_{y}, and obtain the forward/backward tilt rate K2 using a_{y}/a_{z}; and

the cursor moving unit specifically includes:

a timing sub-unit configured to start a preset left/right movement timeout timer T1 and a preset forward/backward movement timeout timer T2;

a determining sub-unit configured to, when the timer T1 or the timer T2 expires, determine whether the tilt rate |K1| or the tilt rate |K2| exceeds a set threshold; and

a cursor moving sub-unit configured to: when the tilt rate |K1| or the tilt rate |K2| exceeds the set threshold, move the cursor one grid left/right or forward/backward, continue to determining movement of the cursor based on the current |K1| or |K2|, and trigger the timing sub-unit.

Wherein, in the timing sub-unit, timing time of the timer T1 and timing time of the timer T2 are preset fixed values; or, timing time of the timer T1 is T1=A1/|K1| and timing time of the timer T2 is T2=A2/|K2|, wherein A1 and A2 are constants;

when T1=A1/|K1| and T2=A2/|K2|, before the cursor moving sub-unit triggers the timing sub-unit, the timing time T1 or T2 is re-calculated based on the current |K1| or |K2|.

Preferably, the mobile terminal of the disclosure further includes:

a detecting unit configured to: determine whether a movement function of a gravity induction cursor is enabled, and trigger the information acquiring unit when the movement function of the gravity induction cursor is enabled.

With the method of the disclosure, a user needs only to press a movement on-off key during the process of editing, and tilts a mobile terminal in all directions so as to move a cursor at will. The severer tilt is, and the faster the cursor moves. In this way, the trouble of repeated touch or key-press is reduced, high efficiency and convenience is achieved, and user experience is enhanced.

Obviously, those skilled in the art can make various modifications and variations to the disclosure without departing from the spirit and scope of the disclosure. Thus, if these modifications and variations of the disclosure fall within the scope of the claims of the disclosure and equivalent technologies thereof, the disclosure is also intended to include these modifications and variations.

### INDUSTRIAL APPLICABILITY

The disclosure utilizes a gravity inductor of a mobile terminal to implement movement of a cursor, reduces the trouble of moving the cursor by repeated touch or key-press, and solves the problem of an inaccuracy location of the cursor by a touch screen and a tedious operation of cursor location by key-press. A user needs only to tilt a mobile terminal in all directions during a process of editing, and then a cursor can be moved at will. Therefore, an efficiency of cursor location is increased, and user experience is enhanced.

1. A method for implementing movement of a cursor by a mobile terminal, comprising:
acquiring accelerated velocities aₓ, a_{y}, and a_{z} of a mobile terminal in a set three-dimensional coordinate system;
calculating a current left/right tilt rate K1 and a current forward/backward tilt rate K2 of the mobile terminal; and
moving a cursor left/right or forward/backward based on the tilt rate K1 and the tilt rate K2.

2. The method according to claim 1, wherein the step of acquiring accelerated velocities aₓ, a_{y}, and a_{z} of a mobile terminal in a set three-dimensional coordinate system comprises:
subscribing an acceleration induction vector GVector event, and acquiring the accelerated velocities aₓ, a_{y}, and a_{z} of the mobile terminal in set three-dimensional coordinate axes according to acquired GVector information in real time.

3. The method according to claim 1, wherein the step of calculating a current left/right tilt rate K1 and a current forward/backward tilt rate K2 of the mobile terminal comprises:
according to the accelerated velocities aₓ, a_{y}, and a_{z}, obtaining the left/right tilt rate K1 using aₓ/a_{y}, and obtaining the forward/backward tilt rate K2 using a_{y}/a_{z}.

4. The method according to claim 1, wherein the step of moving a cursor left/right or forward/backward based on the tilt rate K1 and the tilt rate K2 comprises:
A: starting a preset left/right movement timeout timer T1 and a preset forward/backward movement timeout timer T2;
B: when the timer T1 or the timer T2 expires, determining whether the tilt rate |K1| or the tilt rate |K2| exceeds a set threshold; and
C: when the tilt rate |K1| or the tilt rate |K2| exceeds the set threshold, moving the cursor one grid left/right or forward/backward, continuing to determining movement of the cursor based on the current |K1| or |K2|, and returning to the step A.

5. The method according to claim 4, wherein
timing time of the timer T1 and timing time of the timer T2 are preset fixed values; or, timing time of the timer T1 is T1=A1/|K1| and timing time of the timer T2 is T2=A2/|K2|, wherein A1 and A2 are constants; and
when T1=A1/|K1| and T2=A2/|K2|, in the step C, before returning to the step A, re-calculating the timing time T1 or T2 based on the current |K1| or |K2|.

6. The method according to claim 1, further comprising: before acquiring the accelerated velocities aₓ, a_{y}, and a_{z} of the mobile terminal in the set three-dimensional coordinate system;
determining whether a movement function of a gravity induction cursor is enabled, and when the movement function of the gravity induction cursor is enabled, triggering an operation of acquiring the accelerated velocities aₓ, a_{y}, and a_{z} of the mobile terminal in the set three-dimensional coordinate system.

7. A mobile terminal, comprising:
an information acquiring unit configured to acquire accelerated velocities aₓ, a_{y}, and a_{z} of a mobile terminal in a set three-dimensional coordinate system;
a tilt rate calculating unit configured to calculate a current left/right tilt rate K1 and a current forward/backward tilt rate K2 of the mobile terminal; and
a cursor moving unit configured to move a cursor left/right or forward/backward based on the tilt rate K1 and the tilt rate K2.

8. The mobile terminal according to claim 7, wherein
the information acquiring unit is configured to subscribe an acceleration induction vector GVector event, and acquire the accelerated velocities aₓ, a_{y}, and a_{z} of the mobile terminal in set three-dimensional coordinate axes according to acquired GVector information in real time;
the tilt rate calculating unit is configured to, according to the accelerated velocities aₓ, a_{y}, and a_{z}, obtain the left/right tilt rate K1 using aₓ/a_{y}, and obtain the forward/backward tilt rate K2 using a_{y}/a_{z}; and
the cursor moving unit comprises:
a timing sub-unit configured to start a preset left/right movement timeout timer T1 and a preset forward/backward movement timeout timer T2;
a determining sub-unit configured to, when the timer T1 or the timer T2 expires, determine whether the tilt rate |K1| or the tilt rate |K2| exceeds a set threshold; and
a cursor moving sub-unit configured to: when the tilt rate |K1| or the tilt rate |K2| exceeds the set threshold, move the cursor one grid left/right or forward/backward, continue to determining movement of the cursor based on the current |K1| or |K2|, and trigger the timing sub-unit.

9. The mobile terminal according to claim 8, wherein in the timing sub-unit, timing time of the timer T1 and timing time of the timer T2 are preset fixed values; or, timing time of the timer T1 is T1=A1/|K1| and timing time of the timer T2 is T2=A2/|K2|, wherein A1 and A2 are constants;
when T1=A1/|K1| and T2=A2/|K2|, before the cursor moving sub-unit triggers the timing sub-unit, the timing time T1 or T2 is re-calculated based on the current |K1| or |K2|.

10. The mobile terminal according to claim 7, further comprising:
a detecting unit configured to: determine whether a movement function of a gravity induction cursor is enabled, and trigger the information acquiring unit when the movement function of the gravity induction cursor is enabled.
